(19) United States
(12) Patent Application Publication
(10) Pub. No.: US 2018/0096270 A1
(43) Pub. Date: Apr. 5, 2018

(54) SYSTEMS AND METHODS TO ENABLE THE DELIVERY OF RETAIL PRODUCTS

(71) Applicant: Wal-Mart Stores, Inc., Bentonville, AR (US)

(72) Inventors: Donald R. High, Noel, MO (US); John P. Thompson, Bentonville, AR (US); David C. Winkle, Bella Vista, AR (US)

(21) Appl. No.: 15/715,511

(22) Filed: Sep. 26, 2017

Related U.S. Application Data
(60) Provisional application No. 62/403,901, filed on Oct. 4, 2016.

(51) Int. Cl. G06Q 10/06; G07C 9/00; G06Q 10/08

(52) U.S. Cl. CPC G06Q 10/0633; G07C 9/00166; G07C 2009/0092; G06Q 10/0832; G07C 9/00896

(57) ABSTRACT

In some embodiments, systems, apparatuses and methods are provided herein useful to enable the delivery of retail products. Some embodiments include product receiving systems comprising: a first access door and a package compartment cooperated with the first access door; a wireless communication transceiver; a control circuit coupled with the transceiver; and a memory coupled to the control circuit and storing computer instructions that when executed by the control circuit cause the control circuit to: determine that a delivery vehicle is within a threshold distance and intends to deliver a package into the package compartment; determine whether a time that the delivery vehicle intends to deliver the package corresponds with a customer specified delivery restriction; and wirelessly communicate a denial notification to the delivery vehicle denying the delivery when the time that the delivery vehicle intends to deliver the package is inconsistent with the delivery restriction.

### CROSS-REFERENCE TO RELATED APPLICATION

This application claims the benefit of U.S. Provisional Application No. 62/403,901, filed Oct. 4, 2016, which is incorporated herein by reference in its entirety.

### TECHNICAL FIELD

This invention relates generally to secure delivery of products to customers.

### BACKGROUND

In a modern retail environment, there is a need to improve the customer service and/or convenience for the customer. One aspect of customer service is the delivery of products. There are numerous ways to delivery products to customers. Getting the product to a delivery location, however, can cause undesirable delays, can add cost and reduce revenue.

### BRIEF DESCRIPTION OF THE DRAWINGS

Disclosed herein are embodiments of systems, apparatuses and methods pertaining the secure delivery of products to customers? This description includes drawings, wherein:

FIG. 1 illustrates a simplified block diagram of an exemplary product delivery system, in accordance with some embodiments.

FIG. 2 illustrates an exemplary system for use in implementing methods, techniques, devices, apparatuses, and systems to distribute and/or allocate retail products, in accordance with some embodiments.

FIG. 3 illustrates a simplified block diagram of an exemplary product receiving system, in accordance with some embodiments.

FIG. 4 illustrates a simplified flow diagram of an exemplary process of restricting deliveries to a product receiving system based on customer specified restrictions, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods are provided herein useful to enable secure delivery of products to customers. Some embodiments comprise product receiving systems to enable delivery of products. The product receiving systems include one or more access doors and at least one package compartment cooperated with the access doors. The access doors are typically locked to limit access to the package compartment to a delivery vehicle, delivery person or other entity delivering products, and an authorized customer. In some implementations, a product receiving system is similar to or comprises one or more product delivery lockers or other such devices that can receive products and limit access to the received products to the customer for whom the product is delivered. The product receiving systems typically further includes a wireless communication transceiver and a control circuit coupled with the transceiver. The control circuit determines when a delivery vehicle is within a threshold distance and intends to deliver one or more products, packages, or the like into the package compartment. The below description generally refers to a package. Such packages may simply be a product, however, the package may include one or more products, protective packaging, wrappings, and the like. The system typically further determines whether the delivery complies one or more customer specified delivery restriction. For example, the system may confirm that a time that the delivery vehicle intends to deliver the package corresponds with a customer specified delivery restriction. When the time that the delivery vehicle intends to deliver the package is inconsistent with the delivery restriction, the system can wirelessly communicate a denial notification to the delivery vehicle denying the delivery when the time that the delivery vehicle intends to deliver the package is inconsistent with the specified delivery restriction.

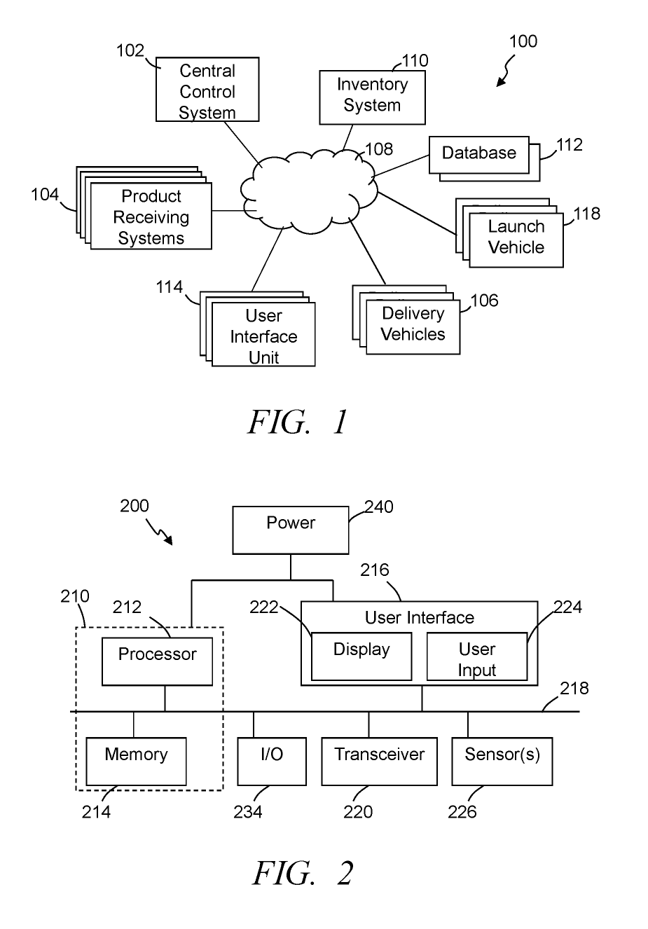

FIG. 1 illustrates a simplified block diagram of an exemplary product delivery system 100, in accordance with some embodiments. The product delivery system 100 includes one or more central control systems 102, multiple product receiving systems 104, and multiple delivery vehicles 106. Typically, the delivery vehicles are in communication over the distributed computer and/or communication network 108 with at least the central control system 102. In some embodiments, one or more of the product receiving systems 104 are in communication with the central control system through the communication network 108. Further, some embodiments include one or more inventory systems 110 and/or the central control system includes or is in communication with an inventory system. The central control system may further include and/or couple with one or more databases 112.

The product receiving systems are geographically distributed over one or more geographic areas (e.g., neighborhoods, cities, counties, states, etc.), and in some instances may be associated with a particular building or one or more customers. The central control system controls the distribution and/or provides delivery route information to the UDVs to implement product deliveries to the product receiving systems 104. One or more retailers and/or product distribution center systems are accessible over the one or more distributed networks by customers using customer user interface units 114 (e.g., smartphones, tablets, laptops, computers, etc.) to purchase one or more products. Further, the product orders may designate and/or request that the one or more products of the order be delivered to a product receiving system 104 associated with the customer. Based on the received orders, the central control system (or a scheduling system) can schedule deliveries and provide relevant delivery routing information (e.g., street map routing, turns, distances, flight path information, etc.) to be followed by the delivery vehicle 106 in delivering the one or more products. In some instances, the delivery routing is based in part on the type of delivery vehicle. For example, different routing is specified for ground based delivery vehicles versus aerial delivery vehicles.

Additionally, some embodiments utilize one or more distribution or launch vehicles 118. The launch vehicles can transport one or more unmanned delivery vehicles and products to be delivered by those vehicles to strategic launch locations. The relevant delivery vehicles can be released from the launch vehicle to implement the intended unmanned delivery. The delivery vehicles can then return to the launch location of a different pickup location. Again, the central control system or routing system can define the launch and/or pickup locations, as well as a route the launch vehicles are to travel in transporting the delivery vehicles.

The circuits, circuitry, systems, devices, processes, methods, techniques, functionality, services, servers, sources and the like described herein may be utilized, implemented and/or run on many different types of devices and/or systems. FIG. 2 illustrates an exemplary system 200 that may be used for implementing any of the components, circuits, circuitry, systems, functionality, apparatuses, processes, or devices of the product delivery system 100, and/or other above or below mentioned systems or devices, or parts of such circuits, circuitry, functionality, systems, apparatuses, processes, or devices. For example, the system 200 may be used to implement some or all of the central control system 102, the product receiving systems 104, delivery vehicles 106, inventory system 110, user interface units 114, and/or other such components, circuitry, functionality and/or devices. However, the use of the system 200 or any portion thereof is certainly not required.

By way of example, the system 200 may comprise a control circuit or processor module 212, memory 214, and one or more communication links, paths, buses or the like 218. Some embodiments may include one or more user interfaces 216, and/or one or more internal and/or external power sources or supplies 240. The control circuit 212 can be implemented through one or more processors, microprocessors, central processing units, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 212 can be part of control circuitry and/or a control system 210, which may be implemented through one or more processors with access to one or more memory 214 that can store instructions, code and the like that is implemented by the control circuit and/or processors to implement intended functionality. In some applications, the control circuit and/or memory may be distributed over the communications network 108 (e.g., LAN, WAN, Internet) providing distributed and/or redundant processing and functionality. Again, the system 200 may be used to implement one or more of the above or below, or parts of, components, circuits, systems, processes and the like. For example, the system may implement the central control system 102 with the control circuit being a central control circuit, the product receiving system with a control circuit, or other components.

The user interface 216 can allow a user to interact with the system 200 and receive information through the system. In some instances, the user interface 216 includes a display 222 and/or one or more user inputs 224, such as buttons, touch screen, track ball, keyboard, mouse, etc., which can be part of or wired or wirelessly coupled with the system 200. Typically, the system 200 further includes one or more communication interfaces, ports, transceivers 220 and the like allowing the system 200 to communicate over a communication bus, a distributed computer and/or communication network 108 (e.g., a local area network (LAN), the Internet, wide area network (WAN), etc.), communication link 218, other networks or communication channels with other devices and/or other such communications or combination of two or more of such communication methods. Further the transceiver 220 can be configured for wired, wireless, optical, fiber optical cable, satellite, or other such communication configurations or combinations of two or more of such communications. Some embodiments include one or more input/output (I/O) ports 234 that allow one or more devices to couple with the system 200. The I/O ports can be substantially any relevant port or combinations of ports, such as but not limited to USB, Ethernet, or other such ports. The I/O interface 234 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 226 to provide information to the system and/or sensor information that is communicated to another component, such as the central control system, a delivery vehicle, etc. The sensors can include substantially any relevant sensor, such as distance measurement sensors (e.g., optical units, sound/ultrasound units, etc.), optical based scanning sensors to sense and read optical patterns (e.g., bar codes), radio frequency identification (RFID) tag reader sensors capable of reading RFID tags in proximity to the sensor, cameras, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 200 comprises an example of a control and/or processor-based system with the control circuit 212. Again, the control circuit 212 can be implemented through one or more processors, controllers, central processing units, logic, software and the like. Further, in some implementations the control circuit 212 may provide multiprocessor functionality.

The memory 214, which can be accessed by the control circuit 212, typically includes one or more processor readable and/or computer readable media accessed by at least the control circuit 212, and can include volatile and/or nonvolatile media, such as RAM, ROM, EEPROM, flash memory and/or other memory technology. Further, the memory 214 is shown as internal to the control system 210; however, the memory 214 can be internal, external or a combination of internal and external memory. Similarly, some or all of the memory 214 can be internal, external or a combination of internal and external memory of the control circuit 212. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 108. The memory 214 can store code, software, executables, scripts, data, content, lists, programming, programs, log or history data, user information, customer information, product information, and the like. While FIG. 2 illustrates the various components being coupled together via a bus, it is understood that the various components may actually be coupled to the control circuit and/or one or more other components directly.

The product receiving systems 104 are configured to be distributed at different geographic locations. Typically, the product receiving systems are secured at a location. In some instances, the product receiving systems may be temporarily located at a delivery location, while in other instances, the may be substantially permanently fixed to a location. Delivery vehicles are directed to a product receiving system associated with a predefined customer and can deposit a product into the product receiving system.

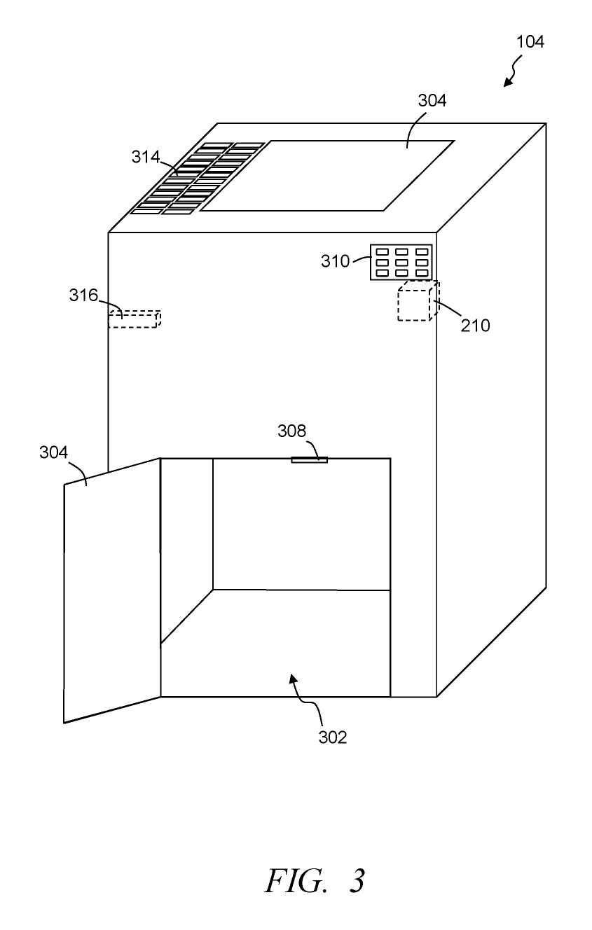

FIG. 3 illustrates a simplified block diagram of an exemplary product receiving system 104, in accordance with some embodiments. The product receiving systems has a housing, shell, or casing that encloses one or more package compartments 302 to receive delivered products, with one or more access doors 304 cooperated with each of the one or more package compartments. Some embodiments include multiple access doors 304 that can be utilized by different types of delivery vehicles and/or delivery services. For example, some embodiments include a top door that can open to receive products from unmanned aerial vehicles (UAVs). A door activation system can be configured to open the door. The door can lift, slide, drop, rotate, or the like to allow the UAV to lower or drop a product into a package compartment. The top door and/or other portion of the product receiving system can include a landing platform or pad that allows an UAV to land while delivering one or more products. Some embodiments may include one or more ground level access doors to allow a unmanned ground vehicle (UGV) to deliver a product (e.g., by partially or fully driving into a package compartment, by pushing a product through an access door, etc.). Other access doors may be positioned to face toward a street with an access door that can be accessed by a delivery person.

At least one locking system 308 is typically cooperated with each access door to prevent unauthorized access. The product receiving system further includes a power source, which can include, for example, a rechargeable battery, capacitor or other such rechargeable source, and/or can connect to external power. Some embodiments include one or more solar panels 314 that can recharge a local rechargeable power source. A wired and/or wireless communication transceiver 220 can provide a control circuit 210 of the product receiving system 104 with communication with the central control system 102, delivery vehicles 106, customer's user interface units 114, and the like. The control circuit can further be communicatively coupled with the locking system to control the locking system. For example, a customer may enter a user access code into a key pad 310 or other interface of the product receiving system, communicate an access code from a user interface unit, or the like, and the control circuit can activate the locking system to unlock in response to confirming the accuracy of the access code, authenticating a user interface unit, and/or taking other such security actions. In some embodiments, the product receiving systems include one or more temperature control systems 316 associated with one or more package compartments, which are configured to maintain the package compartment at desired temperature and/or temperature threshold associated with one or more products placed within that package compartment.

In some embodiments, the control circuit of the product receiving system is configured to determine that a delivery vehicle 106 is within a threshold distance of the product receiving system and intends to deliver a package into the package compartment. In some instances, the delivery vehicle wirelessly communicates a notification and/or request for access to the product receiving system. In some instances, the product receiving system may detect an RFID tag of the delivery vehicle. Further, the central control system 102 may notify the product receiving system of an expected time of delivery and the control circuit of the product delivery system can activate the transceiver in attempts to establish a wireless communication connection with the delivery vehicle. The communication may be via Bluetooth, cellular, Wi-Fi, RFID, other wired or wireless communications, or combination of two or more of such methods.

The control circuit is further configured to receive one or more customer specified delivery restrictions. These restricts can be set by customers regarding delivery parameters, such as but not limited to timing, mode of delivery, types of products, sources of products, delivery services, weight, delivery location, proximity of customer, other such parameters, and often two or more of such parameters. For example, a customer associated with a product receiving system may specify delivery time restrictions regarding when products can be delivered to that product receiving system, and/or time restrictions corresponding to when products cannot be delivered to that product receiving system. In some instances, a customer may restrict deliveries to when the customer is at home, when the customer is at home during certain hours, etc. As another example, a customer may restrict whether and/or when products that have to be temperature controlled can be delivered, and these times may be different for products that are to be kept cold, versus products that are to be kept warm. Another example includes a customer setting limits on whether alcoholic beverages and/or prescription medications can be delivered and/or when alcoholic beverages and/or prescription medications can be delivered. In some instances, the central control system may learn over time based on customer actions (e.g., failure to retrieve items, complaints, returns, etc.). Similarly, some restrictions may be temporary restrictions, such as when a customer is on vacation, while kids are on break from school, etc. In some embodiments, the customer specified delivery restrictions can include alternate delivery options in the event that a delivery does not comply with one or more other delivery restrictions. For example, an alternate option may direct the delivery to a different product receiving system.

The control circuit of the product receiving system can evaluate delivery parameters relative to the one or more delivery restrictions to determine whether a delivery complies with the restrictions. When the delivery does not comply, the control circuit can take an action associated with which the delivery restriction is not complying. For example, a customer can specify that if a delivery does not comply with delivery time restrictions, the delivery is to be rejected until the delivery complies with the time restrictions, and the control circuit can cause a notification to be sent to the delivery vehicle and/or delivery personnel rejecting the delivery. Additionally or alternatively, the delivery vehicle and/or delivery personal may be notified of the restrictions and/or provided one or more alternatives.

In some embodiments, for example, the control circuit determines whether a time that the delivery vehicle intends to deliver the package corresponds with a customer specified delivery restriction. When it does the control circuit may cause a notification to be communicated to the delivery vehicle confirming the delivery, opening one or more access doors, etc. In some embodiments, the control circuit causes the wireless communication of a denial notification to the delivery vehicle denying the delivery when the delivery does not comply with a restriction, such as when the time that the delivery vehicle intends to deliver the package is inconsistent with the delivery restriction.

The control circuit, in some embodiments, may cause alternate options to be communicated to the delivery vehicle and/or a delivery service operating and/or controlling the delivery vehicle. For example, the control circuit can communicate an instruction to cause the delivery vehicle to be rerouted to an alternate delivery location (e.g., neighbors, office, etc.) and/or alternate product receiving system when the delivery does not comply with one or a combination of delivery restrictions. Additionally or alternatively, the control circuit may communicates an instruction to cause the delivery of the package to occur at a different time that is consistent with the delivery restriction. The communication may be direct to the delivery vehicle. In other instances, the communication may be to the central control system that can direct communications to the delivery vehicle and/or a delivery service. Similarly, the control circuit of the product receiving system can communicate one or more alternate options (e.g., alternate delivery time that complies with the customers restrictions) to a delivery service and/or launch vehicle.

When the delivery complies with one and often multiple customer restrictions, such when the time that the delivery vehicle intends to deliver one or more packages corresponds with one or more delivery restrictions, the control circuit can authorize one or more access doors 304 to be unlocked and/or opened. Further, the control circuit may identify that the delivery vehicle is a first type of delivery vehicle of multiple different types of delivery vehicles from which packages can be received. The control circuit may unlock a first access door of multiple different access doors as a function of the delivery vehicle being the first type of delivery vehicle and enabling the package to be received through the first access door.

In some embodiments, the central control system and/or a delivery service may communicate delivery vehicle identifier information and/or authentication information. Additionally or alternatively, the product receiving system may communicate authentication information (e.g., a code, encryption key, password, etc.) to the central control system to be relayed to the delivery vehicle. Further, the product receiving system may be configured to communicate directly with the delivery vehicle to receive an authentication communication from the delivery vehicle. The authentication information may include a code, password, content encrypted according to a predefined key, and/or other such authentication information. The control circuit can authenticate the delivery vehicle and confirm, prior to unlocking an access door, that the delivery vehicle is authorized to deposit a package.

One or more sensors 226 may be included with and/or within the product receiving system. In some embodiments, include a plurality of sensors coupled with the control circuit with the control circuit configured to receive sensor data from the sensors. One or more of the sensors can provide sensor information corresponding to at least a product within a package being received and/or deposited within the product compartment. Based on the sensor data, the control circuit can be configured to identify the product and/or validate the product is consistent with an expected product. For example, the central control system may communicate an RFID tag identifier, a bar code, a weight, dimensions, labeling information, other such information that can be used to identify the product, and/or a combination of two or more of such information. The one or more sensors may include an RFID tag reader, a camera and text capture system, measurement devices to measure dimensions of a product and/or package, a scale or weight detector, and/or other such sensors. Further, in some applications, the control circuit can confirm a complete order and/or communicate product identifier information to have the central control system confirm one or more products and/or a complete order. Similarly, the control circuit can confirm that an unexpected or extra product was not included in the delivery. In some embodiments, the control circuit can notify the delivery vehicle and/or reject the delivery when an incorrect product is detected. Additionally or alternatively, the control circuit can notify the central control system that an incorrect product has been delivered allowing the central control circuit to schedule a retrieval of the product, which may include rerouting the same delivery vehicle when the delivery vehicle is within a threshold distance of the product receiving system. In some embodiments, the control circuit can communicate a notification to a customer of the delivery including identifier information of the product. This notification may be by text message, cellular call, email, other such communication, or combination of two or more of such communications.

Some embodiments include one or more temperature control systems 316 within and/or affixed to the product receiving system. The temperature control systems can cooperate with one or more the package compartments. The control circuit of the product receiving system 104 can be configured to determine a threshold temperature at which the product is to be maintained above or below. For example, the control circuit may communicate with the delivery vehicle, the central control system or other source to obtain product conditions, which may include a desired temperature, one or more temperature thresholds, one or more moisture level thresholds within the package compartment, and/or other such information. The control circuit can communicate control instructions to control one or more temperature control systems 316 to control a temperature within one or more package compartments based on one or more threshold temperatures.

Some embodiments provide a product receiving system comprising a delivery locker system that opens one of multiple access or delivery doors based on a type of delivery vehicle. Each of the multiple access doors cooperated with at least one package compartment. A control circuit couples with a wireless transceiver and memory storing computer instructions that when executed by the control circuit. The control circuit, in some applications, is configured to receive a communication from a delivery vehicle carrying one or more packages intended for delivery and identify that the delivery vehicle is a first type of delivery vehicle of multiple different types of delivery vehicles from which packages can be received. The control circuit can activate at least one locking system 308 to unlock an access door of the multiple access doors as a function of the delivery vehicle being the first type of delivery vehicle and enabling the one or more packages to be received through the access door. A door control system 320 may further cooperate with one or more access doors and be activated by the control circuit to open and close the corresponding access door in response to control signals. The door control system may include one or more motors, hydraulics, linear motors, screws shafts, and/or other such methods, or combination of two or more of such methods of opening and closing one or more an access doors.

In identifying the type of delivery vehicle, in some instances the control circuit may identify that a delivery vehicle is an autonomous unmanned ground vehicle carrying the one or more packages. Accordingly, the control circuit can the unlocking and opening of an access door that is accessible to the ground vehicle and enabling the delivery vehicle to deposit at least one package into a package compartment. In some embodiments, the control circuit may receive a communication from a delivery vehicle that is an unmanned aircraft system (UAS). For example, identifying information of a second delivery vehicle carrying at least a second package intended for delivery may be received. The control circuit can identify that the second delivery vehicle is an unmanned aircraft system (UAS) type of delivery vehicle of the multiple different types of delivery vehicles. Based on the delivery vehicle being a UAS, the control circuit can cause the unlocking of a second access door of the multiple access doors as a function of the delivery vehicle being the UAS type of delivery vehicle and enabling the second delivery vehicle to deposit the second package through the second access door. In some embodiments, the second access door may be oriented toward the sky and when opened is configured to receive the second package dropped by the second delivery vehicle from a threshold distance above the second access door.

Some embodiments include a plurality of sensors communicatively coupled with the control circuit so that the control circuit receives sensor data from at least one sensor of the plurality of sensors and corresponding to at least a product within the package being delivered and/or within the package compartment. The product can be identified based on the sensor data, and a notification communicated to a customer regarding the delivery and including identifier information of the product. In some embodiments, the control circuit and/or a temperature control system determines a threshold temperature at which a product is to be maintained above or below. A product compartment that can be temperature controlled can be identified and a corresponding access door can be unlocked based on the temperature threshold associated with the product enabling the product to be deposited through the access door and into the package compartment based on the temperature threshold associated with the product. The control circuit and/or a temperature control system can control a temperature within the package compartment based on the temperature threshold.

In some embodiments, the control circuit is configured to receive an authentication communication from the delivery vehicle. The control circuit can then authenticate the delivery vehicle, and confirm, prior to unlocking an access door, that the delivery vehicle is authorized to deposit a package. In some applications, the control circuit further confirms that a delivery complies with one or more delivery restrictions. The control circuit may, for example, determine whether a time that the delivery vehicle intends to deliver a package corresponds with a customer specified delivery restriction, and authorizes the access door to be unlocked and/or opened when the time that the delivery vehicle intends to deliver the package corresponds with the customer specified delivery restriction.

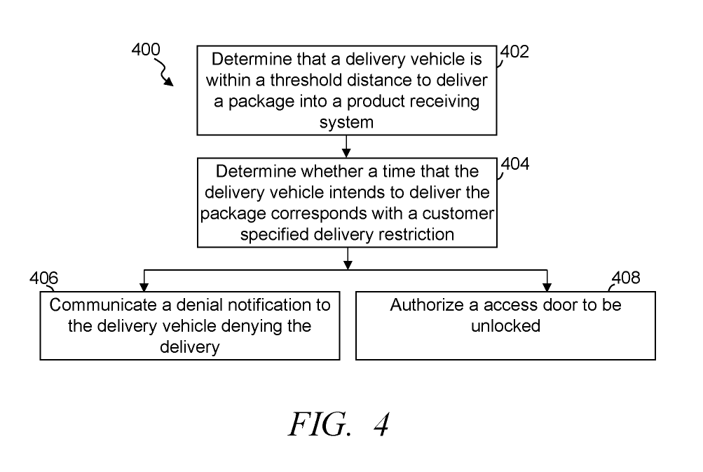

FIG. 4 illustrates a simplified flow diagram of an exemplary process 400 of restricting deliveries to a product receiving system 104 based on customer specified restrictions, in accordance with some embodiments. In step 402, a control circuit of a product receiving system determines that a delivery vehicle 106 is within a threshold distance and intends to deliver a package into a package compartment 302 of the product receiving system. Again, the product receiving system is one of multiple different product receiving systems positioned at different locations throughout one or more geographic areas. Further, some of the product receiving systems may be associated with a specific customer (e.g., located at a customer's home, office, etc.), while others may be more generally utilized and accessed by multiple different customers (e.g., located at an apartment complex, neighborhood, gated community, etc.). Additionally, those product receiving systems that can potentially be utilized by multiple customers are typically restricted to one of those customers (or customers that are associated, such as family members) when a product is placed into the product receiving system.

In step 404, it is determined whether the delivery corresponds with one or more customer specified delivery, such as whether a delivery time that the delivery vehicle intends to deliver the package corresponds with one or more customer specified delivery restrictions. In step 406, a denial notification is wirelessly communicated to the delivery vehicle denying the delivery when the delivery is inconsistent with one or more delivery restrictions and/or within threshold variations from one or more delivery restrictions. For example, a denial notification can be wirelessly communicated to the delivery vehicle when the time that the delivery vehicle intends to deliver the package is inconsistent with a delivery time delivery restriction. In step 408, an access door 304 can be authorized to be unlocked when the delivery corresponds with the one or more delivery restrictions (e.g., when the time that the delivery vehicle intends to deliver the package corresponds with the delivery time delivery restriction, when a type of product being delivered is consistent with a product restriction, when a customer or a customer's smartphone is within a threshold distance of the product receiving system, when a product is at a temperature that is within a threshold of a temperature restriction, when a weight of the product corresponds with a weight restriction, and other such restrictions). Some embodiments may consider a combination of two or more of such restrictions, and in some instances one or more restrictions may be dependent on one or more other restrictions. For example, a time restriction may be dependent on a type of product being delivered, such as limiting delivery of a prescription to a time when the customer is expected to home. As another example, a customer location restriction may be dependent on a type of product being delivered, such as restricting the delivery of alcoholic beverages to when the customer is within a threshold distance of the product receiving system.

Some embodiments communicate one or more instructions to cause the delivery vehicle to be rerouted to an alternate delivery location when the delivery does not comply with one or more delivery restrictions. The instructions may be communicated from the product receiving system directly to the delivery vehicle, while in other instances, the product receiving system may notify the central control system 102, third party delivery service controlling the delivery vehicle, or the like, which may cause instructions to be communicated to the delivery vehicle redirecting the delivery vehicle to the alternate delivery location. Similarly, one or more instructions can be communicated to cause the delivery of the package to occur at a different time that is consistent with one or more delivery restrictions. Again, this communication may be directly from the product receiving system to the delivery vehicle, while in other instances the product receiving system may send a communication to the central control circuit, third party service, or other entity that can provide routing instructions to the delivery vehicle to the alternate location.

When the delivery complies with delivery restrictions, some embodiments identify that the delivery vehicle is a specific type of delivery vehicle of multiple different types of delivery vehicles from which packages can be received, and the control circuit causes a first access door of multiple different access doors to be unlocked as a function of the delivery vehicle being the first type of delivery vehicle and enabling the package to be received through the first access door. Typically, the product receiving system receives an authentication communication from the delivery vehicle, and can authenticate the delivery vehicle. Based in part on the authentication, the product receiving system can confirm, prior to unlocking an access door, that the delivery vehicle is authorized to deposit a package into the package compartment.

In some embodiments, the product receiving system includes one or more sensors that can, in part, be used to identify and/or confirm products. The control circuit can receive sensor data from one or more sensors of a plurality of sensors and corresponding to at least a product within the package. The sensor data may include RFID tag information, bar code data, picture, text capture data, weight data, dimensions data, other such sensor data, or combination of two or more of such sensor data. Some embodiments identify one or more products and/or packages a package compartment based on the sensor data. The control circuit may cause a notification to be communicated to a customer of the delivery including identifier information of one or more products.

Some embodiments further control the temperature within one or more of the package compartments 302. A threshold temperature associated with the product can be determined. A temperature control system 316 cooperated with the package compartment can be controlled to control a temperature within the package compartment based on the threshold temperature (e.g., maintained below or above the temperature threshold, maintained within a threshold variation of the temperature threshold, etc.).

Some embodiments receive, through a wireless transceiver, a wireless communication from a delivery vehicle carrying a package intended for delivery. A control circuit can identify that the delivery vehicle is a first type of delivery vehicle of multiple different types of delivery vehicles from which packages can be received. One or more access doors of multiple different access doors of a product receiving system can be unlocked as a function of the delivery vehicle being the first type of delivery vehicle and enabling the package to be received through the unlocked access door. In some embodiments, the type of delivery vehicle is identified as an autonomous ground vehicle carrying the package. Accordingly, the unlocking the access door can comprise unlocking and opening the access door which is accessible to a ground based vehicle and enabling the delivery vehicle to deposit the package into a package compartment cooperated with the unlocked access door accessible to the ground based vehicle.

A communication may be received from another delivery vehicle carrying at least a second package intended for delivery at the product receiving system. The second delivery vehicle can be identified as an unmanned aircraft system (UAS) type of delivery vehicle of the multiple different types of delivery vehicles. A second access door of the multiple access doors can be unlocked and/or opened as a function of the delivery vehicle being the UAS type of delivery vehicle and enabling the second delivery vehicle to deposit the second package through the second access door. Some embodiments cause the second access door to open, which may be oriented toward the sky when opened. The second package can be received through the second access door by the UAS dropping the second package from a threshold distance above the second access door. A plurality of sensors may be coupled with the control circuit, and the control circuit may be configured to receive sensor data from one or more sensors with the sensor data corresponding to at least a product within a delivered package. The first product can be identified based on the sensor data, a notification can be communicated to a customer regarding the delivery and including identifier information of the product.

Some embodiments determine a temperature threshold associated with a product. An access door can be unlocked and/or opened based on temperature threshold associated with the product, and enabling the first product to be deposited through the access door and into the package compartment based on the temperature threshold. A temperature is controlled within the package compartment based on the temperature threshold. In some embodiments, an authentication communication is received from the delivery vehicle, which is used to authenticate the delivery vehicle. Prior to unlocking an access door, the system can confirm the delivery vehicle is authorized to deposit a package at the product receiving system. Some embodiments determine whether a time that the delivery vehicle intends to deliver a package corresponds with a customer specified delivery restriction, and authorizes the access door to be unlocked and/or opened when the time that the delivery vehicle intends to deliver the package corresponds with the customer specified delivery restriction.

Some embodiments include systems to enable delivery of products, comprising: a first access door and a package compartment cooperated with the first access door; a wireless communication transceiver; a control circuit coupled with the transceiver; and a memory coupled to the control circuit and storing computer instructions that when executed by the control circuit cause the control circuit to: determine that a delivery vehicle is within a threshold distance and intends to deliver a package into the package compartment; determine whether a time that the delivery vehicle intends to deliver the package corresponds with a customer specified delivery restriction; and wirelessly communicate a denial notification to the delivery vehicle denying the delivery when the time that the delivery vehicle intends to deliver the package is inconsistent with the delivery restriction.

In some embodiments, methods are provided to restrict delivery of products to a product receiving system. Some of these embodiments comprise: by a control circuit of a product receiving system of multiple product receiving distributed through one or more geographic areas: determining that a delivery vehicle is within a threshold distance and intends to deliver a package into a package compartment of the product receiving system; determining whether a time that the delivery vehicle intends to deliver the package corresponds with a customer specified delivery restriction; and wirelessly communicating a denial notification to the delivery vehicle denying the delivery when the time that the delivery vehicle intends to deliver the package is inconsistent with the delivery restriction.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A product receiving system to enable delivery of products, comprising:
a first access door and a package compartment cooperated with the first access door;
a wireless communication transceiver;
a control circuit coupled with the transceiver; and
a memory coupled to the control circuit and storing computer instructions that when executed by the control circuit cause the control circuit to:
determine that a delivery vehicle is within a threshold distance and intends to deliver a package into the package compartment;
determine whether a time that the delivery vehicle intends to deliver the package corresponds with a customer specified delivery restriction; and
wirelessly communicate a denial notification to the delivery vehicle denying the delivery when the time that the delivery vehicle intends to deliver the package is inconsistent with the delivery restriction.

2. The system of claim 1, wherein the control circuit communicates an instruction to cause the delivery vehicle to be rerouted to an alternate delivery location.

3. The system of claim 1, wherein the control circuit communicates an instruction to cause the delivery of the package to occur at a different time that is consistent with the delivery restriction.

4. The system of claim 1, wherein the control circuit is configured to authorize the first access door to be unlocked when the time that the delivery vehicle intends to deliver the package corresponds with the delivery restriction.

5. The system of claim 4, wherein the control circuit is configured to:
identify that the delivery vehicle is a first type of delivery vehicle of multiple different types of delivery vehicles from which packages can be received; and
unlock the first access door of multiple access doors as a function of the delivery vehicle being the first type of delivery vehicle and enabling the package to be received through the first access door.

6. The system of claim 5, wherein the control circuit is configured to receive an authentication communication from the delivery vehicle, authenticate the delivery vehicle and confirm, prior to unlocking the first access door, the delivery vehicle is authorized to deposit a package.

7. The system of claim 4, further comprising:
a plurality of sensors coupled with the control circuit, wherein the control circuit is further configured to receive sensor data from at least a first sensor of the plurality of sensors and corresponding to at least a product within the package, identify the product based on the sensor data, and communicate a notification to a customer of the delivery including identifier information of the product.

8. The system of claim 7, further comprising:
a temperature control system cooperated with the package compartment;
wherein the control circuit is further configured to determine a threshold temperature associated with the product, and control the temperature control system to control a temperature within the package compartment based on the threshold temperature.

9. A method to restrict delivery of products to a product receiving system, comprising:
by a control circuit of the product receiving system of multiple product receiving distributed through one or more geographic areas:
determining that a delivery vehicle is within a threshold distance and intends to deliver a package into a package compartment of the product receiving system;
determining whether a time that the delivery vehicle intends to deliver the package corresponds with a customer specified delivery restriction; and
wirelessly communicating a denial notification to the delivery vehicle denying the delivery when the time that the delivery vehicle intends to deliver the package is inconsistent with the delivery restriction.

10. The method of claim 9, further comprising:
communicating an instruction to cause the delivery vehicle to be rerouted to an alternate delivery location.

11. The method of claim 9, further comprising:
communicating an instruction to cause the delivery of the package to occur at a different time that is consistent with the delivery restriction.

12. The method of claim 9, further comprising:
authorizing a first access door to be unlocked when the time that the delivery vehicle intends to deliver the package corresponds with the delivery restriction.

13. The method of claim 12, further comprising:
identifying that the delivery vehicle is a first type of delivery vehicle of multiple different types of delivery vehicles from which packages can be received; and
unlocking the first access door of multiple access doors as a function of the delivery vehicle being the first type of delivery vehicle and enabling the package to be received through the first access door.

14. The method of claim 13, further comprising:
receiving an authentication communication from the delivery vehicle;
authenticating the delivery vehicle; and
confirming, prior to unlocking the first access door, the delivery vehicle is authorized to deposit a package.

15. The method of claim 12, further comprising:
receiving sensor data from at least a first sensor of a plurality of sensors and corresponding to at least a product within the package;
identifying the product based on the sensor data; and
causing a notification to be communicated to a customer of the delivery including identifier information of the product.

16. The method of claim 15, further comprising:
determining a threshold temperature associated with the product;
controlling a temperature control system cooperated with the package compartment to control a temperature within the package compartment based on the threshold temperature.
